(19) United States
(12) Patent Application Publication
(10) Pub. No.: US 2013/0138475 A1
(43) Pub. Date: May 30, 2013

(54) SYSTEMS AND METHODS FOR TRANSACTION-BASED SALES LEAD GENERATION

(71) Applicants: G. Austin Allison, Cincinnati, OH (US); Matthew A. Vorst, Blue Ash, OH (US)

(72) Inventors: G. Austin Allison, Cincinnati, OH (US); Matthew A. Vorst, Blue Ash, OH (US)

(21) Appl. No.: 13/688,955

(22) Filed: Nov. 29, 2012

Related U.S. Application Data
(60) Provisional application No. 61/564,874, filed on Nov. 30, 2011.
(60) Provisional application No. 61/657,958, filed on Jun. 11, 2012.

(51) Int. Cl. G06Q 30/02

(52) U.S. Cl. CPC G06Q 30/0201
USPC 705/7.29

(57) ABSTRACT

Systems, methods and apparatus for determining vendors relevant to a transaction. The relevance can be based on a number of factors, such as transaction data, timing data, and behavioral data. The relevant vendors can change over time as additional data become available.

### CROSS-REFERENCE TO RELATED APPLICATIONS

This application claims the benefit of U.S. provisional patent application Ser. No. 61/564,874, filed on Nov. 30, 2011, entitled “Transaction-Based Sales Lead Generation,” and U.S. provisional patent application Ser. No. 61/657,958, filed on Jun. 11, 2012, entitled “Systems and Methods for Transaction-Based Sales Lead Generation,” the disclosures of which are both hereby incorporated by reference herein in their entirety.

### TECHNICAL FIELD

The systems and methods disclosed below relate generally to the field of marketing. More specifically, those systems and methods related to the generation of leads and targeted offers of goods and services for potential sales transactions.

### BRIEF DESCRIPTION OF THE DRAWINGS

FIG. 1 is a system block diagram of a transaction-based document creation and editing system.

FIG. 2 is a system block diagram of a services suggestion system.

FIG. 3 is a system block diagram of a services suggestion system with add-on modules.

FIGS. 4A-6 are views of user interfaces.

FIG. 7 is an example progression identifying suggested vendors over time.

FIG. 8 is a flow diagram of an example operation of the generation of relevant vendor listings.

FIG. 9 is a flow diagram of an example operation of generating a vendor suggestion list.

FIG. 10 is a flow diagram of an example operation to determine the relevance of an example service provider.

FIG. 11 is an example progression of suggested vendors over time for a first party and second party.

FIG. 12 is a diagram of an example real estate agent user interface.

### DETAILED DESCRIPTION

The disclosed subject matter relates to systems and methods for creating and managing electronic communication data and metadata, specifically including such communication data related to sales transactions. Such communication data and metadata can relate to voice, electronic mail, instant messaging, text messaging, or other types of electronic communication. As used in this disclosure, the terms “component,” “system,” and the like refer to a computer-related item such as hardware, software, or firmware. For example, the term component can encompass a process in execution, a processor, a software object, an executable file, or a computing system. Both an application running on a server and the server itself can be components. One or more components can reside within other components. Additionally, a component can be localized on one computer or distributed between two or more computers.

The disclosed systems and methods can be implemented as a method, apparatus, or article of manufacture using standard programming or engineering techniques to produce software, firmware, hardware, or any combination thereof to control a computer to implement the disclosed systems and methods. The term “article of manufacture” is intended to include a computer program accessible from any computer-readable device, carrier, or media. For example, computer readable media can include but are not limited to magnetic storage devices, optical disks, smart cards, flash memory devices, or other memory devices. Additionally a carrier wave or other enabling data carrier can be employed to carry computer-readable electronic data such as those used in transmitting and receiving electronic mail or in accessing a network such as the Internet or a local area network (LAN). Of course, those skilled in the art will recognize from this disclosure that many modifications may be made to this configuration.

The disclosed systems and methods may be implemented without some disclosed specific details. In other instances, structures and devices are shown in block diagram form in order to facilitate description. Additionally, although specific examples set forth may use terminology that is consistent with client/server architectures or may even be examples of client/server implementations, skilled artisans will appreciate that the roles of client and server may be reversed and that the disclosed systems and methods are not limited to client/server architectures and may be readily adapted for use in other architectures, specifically including peer-to-peer (P2P) architectures.

U.S. provisional patent application Ser. No. 61/564,874, filed on Nov. 30, 2011, entitled “TRANSACTION-BASED SALES LEAD GENERATION SYSTEM,” is incorporated by reference herein in its entirety.

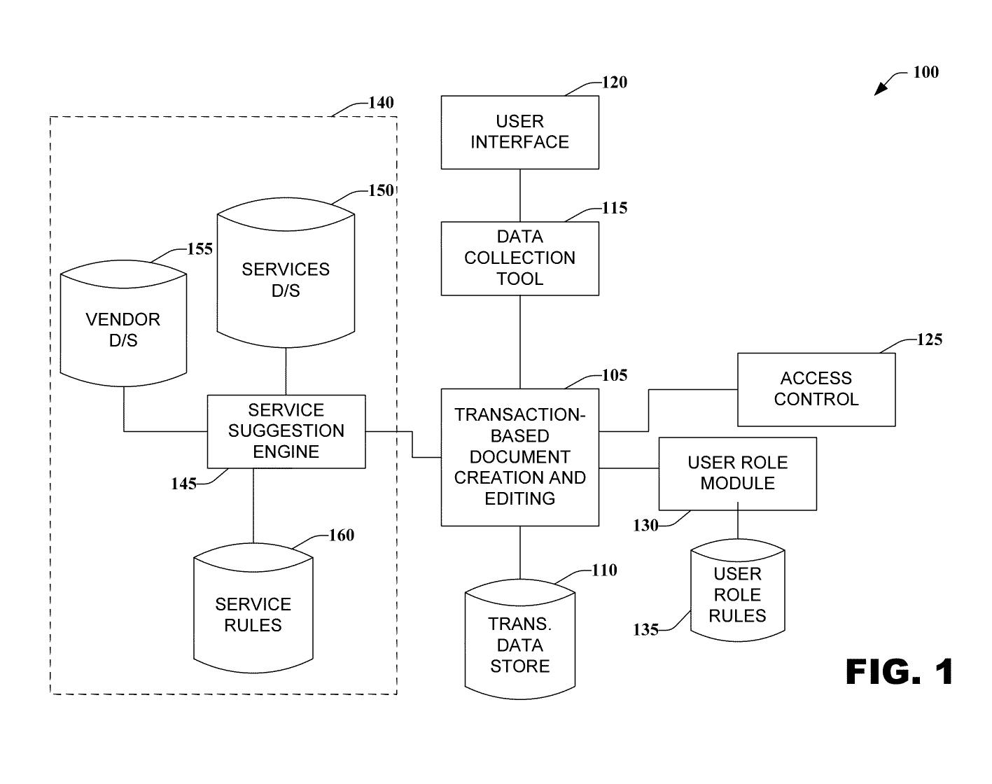

FIG. 1 is a system block diagram of components of a transaction-based sales lead generation system 100. The transaction-based sales lead generation system 100 can be used to identify leads for potential ancillary sales transactions by analyzing data collected regarding a primary sales transaction. Additionally or alternatively, offers to enter into ancillary sales transactions can be created and transmitted to a participant in a primary sales transaction. The transaction-based sales lead generation system 100 can be implemented on a computing system using software, general purpose computing or electronic hardware, specialized computing or electronic hardware, or a combination of these components. Other uses of the transaction-based sales lead generation system 100, as well as alternative implementation details, will be apparent after reading the following description.

The transaction-based sales lead generation system 100 includes a transaction-based document creation and editing module 105. The transaction-based document creation and editing module 105 can generate an initial transaction document, such as a contract, for use as part of a primary sales transaction. The transaction-based document creation and editing module 105 can be implemented as described in U.S. Patent Application No. 61/548,281, filed on Oct. 18, 2011 which is incorporated into this description by reference.

The primary sales transaction can be any suitable business transaction with which one or more ancillary sales transactions may be necessary or desired. For ease and simplicity of description, the information presented below is placed in the context of a residential real estate transaction as the primary transaction. In this context, ancillary transactions can include home inspection, roofing, painting, plumbing, electrical, heating-ventilation-air conditioning (“HVAC”), interior decorating, utility, and moving services, among others.

The transaction-based document creation and editing module 105 can gather data related to a primary sales transaction and can store that data in a transaction data store 110. The transaction data store 100, like other data stores that are described here, can be implemented in any suitable manner, including, but not limited to, a text file, a comma- or tab-delimited text file, a structured text file, an extensible markup language—(“XML”) based file, a relational database, an object-oriented database, or another suitable data structure. Depending upon details of any specific implementation of the transaction-based sales lead generation system 100, more than one type of data store can be used.

Information stored in the transactional data store 110 can include specific details relating to the subject of the primary sales transaction as well as the participants in the primary sales transaction. For example, names, addresses, and contact information for each participant, a description of a residence including street address, real property description, number and types of rooms, square footage, appraised value, asking price, offer price, needed repairs, and tax and assessment information, among other information, can be stored in the transactional data store 110.

The transaction-based document creation and editing system 105 can gather this data through the use of a data collection tool 115. The data collection tool 115 can be implemented in a variety of ways, including as a hypertext markup language—(“HTML”) or web-based form, or as a software module that gathers information from user registration information or other appropriate sources. The transaction-based document creation and editing system 105 can permit access by users through a user interface 120. The user interface 120 can be a web page, a web portal, or a window of a dedicated software application implemented in accordance with a client-server or peer-to-peer communications architecture, among others.

Although not shown, readers should recognize that the transaction-based document creation and editing system 105 can be implemented in a distributed or networked environment. In such an implementation, the user interface 120 can communicate with the transaction-based document creation and editing system 105 across a network or internetwork, such as the Internet. User access to the transaction-based document creation and editing system 105 can be selectively permitted through the use of an access control module 125. The access control module 125 can be a challenge-response system such as a username-password based system, a biometric authentication system, a smart card-based system, a two- or multi-factor authentication system, or another suitable type of access control system.

A user role module 130 can determine which role is played for each participant in the primary sales transaction. For example, the user role module 130 can access the transactional data store 110 to obtain information related to the primary sales transaction. The user role module 130 can then apply logic from a set of user role rules 135 to analyze a history of a document of the transaction-based document creation and editing module 105 to determine whether a user is a seller, a buyer, or a broker in the exemplary real estate transaction set out here. A role assigned to a user can be determined, or re-determined, more than once during a transaction and at multiple points in time before, during, or following a transaction. For example, a user who is assigned the role of “buyer” at the beginning of a residential real estate transaction can be assigned the role of “seller” at the end of that transaction.

For example, the user role module 130 can examine a purchase agreement to see that a purchase agreement that was created by a first party was delivered to a second party by a third party and that the third party added a clause to the document that made an offer to purchase contingent upon the second party's ability to obtain a mortgage. Such clauses are typically associated with buyers. As a result, the user role module 130 could determine that the first party is a seller, the second party is a buyer, and the third party is a broker. Many other scenarios are possible and can be constructed based upon specifics or each type of primary transaction as well as specifics of each document used in connection with the primary sales transaction. Inferences and logical rules can additionally or alternatively take into account multiple types of documents that can be used in a primary sales transaction, such as inspection approvals, among others, to determine roles of participants.

A services suggestion module 140 can include a service suggestion engine 145. The service suggestion engine 145 can access a services data store 150. The services data store 150 can include a variety of services-related information such as general category of service such as plumbing, electrical work, carpentry, or other appropriate service. For each general category, the services data store 150 can include task-level information, such as the specific task involved, goods needed to perform the task, and duration of time normally required to perform the task. For example, the services data store 150 can include a general category of plumbing and a specific task repairing a leaky faucet. An entry for this task can include goods of a replacement washer and retaining screw and an expected duration of 20 minutes.

The service suggestion engine 150 can access a vendor data store 155. The vendor data store 155 can include information for a vendor of a good or service that can be a subject of an ancillary transaction. Information in the vendor data store can include basic identifying and contact information for each vendor. Additionally or alternatively, a variety of scoring, weighting, or ranking methods can be employed to assist in selection of a particular vendor. Such methods can be based on reputation, screening, fees paid by a vendor for inclusion, or a combination of two or more of these methods. Other information can also be included and in in place of, or in addition to, the information just described.

The service suggestion engine 150 can also access a services rules data store 160 that can include a set of rules to determine whether an ancillary service is to be suggested. The service suggestion engine 150 can apply at least one rule in the services rules data store 160 to identify at least one service to suggest to a user, based at least in part on a role played by that user. For each identified service, the service suggestion engine 145 can suggest at least one vendor from the vendor data store 155 capable of performing that service.

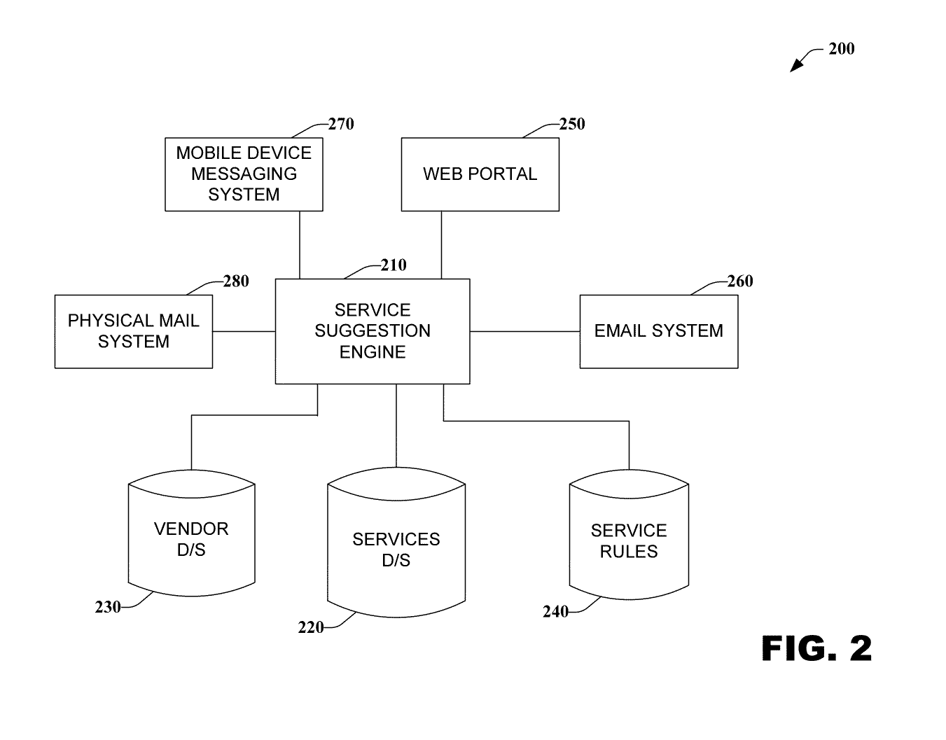

FIG. 2 is a system block diagram of a service suggestion system 200. The service suggestion system 200 can be used as the service suggestion module 140 of FIG. 1. The service suggestion system 200 can include a service suggestion engine 210 that can function similarly to the service suggestion engine 145 shown in FIG. 1. A services data store 220, a vendor data store 230, and a services rules data store 240 can be implemented as the services data store 150, the vendor data store 155, and the services rules data store 160 of FIG. 1, respectively.

The service suggestion engine 210 can send suggestions for services that can form the basis of an ancillary sales transaction in a variety of formats. Each of these formats can be used alone or in various combinations and subcombinations, staggered over varying periods of time or substantially concurrently, as needed or desired. Additionally or alternatively, each of the formats can be used more than once for the same intended ancillary sales transaction.

A web portal 250 can display suggested services from the service suggestion engine 210 on a web page to a user accessing the web portal 250. An email system 260 can send electronic mail messages that include suggestions for services in a variety of standard email formats, including plain text, rich text format (“RTF”) and HTML, using standard Internet protocols such as the simple mail transfer protocol (“SMTP”), version three of the post office protocol (“POP3”) and Internet message access protocol (“IMAP”), or another suitable protocol. A mobile device messaging system 270 can send suggestion messages formatted for mobile devices using mobile-specific protocols such as simple message service (“SMS”), multimedia message service (“MMS”), voice phone calls, and audio-visual conferences, among others. The mobile device messaging system can additionally or alternatively communicate with a dedicated application to access the system that can be hosted on a mobile device. A physical mail system 280 can create printed matter that includes suggestions in formats suitable for delivery by post or courier.

The service suggestion engine 210 can apply programmatic logic from the services rules data store 240 to information related to a primary transaction to suggest at least one service from at least one vendor to be the basis of an ancillary transaction. A service suggestion can be based upon price. For example, if a real estate transaction that is the subject of a primary sales transaction is priced at $150,000, a first set of services can be suggested. If a second, different real estate transaction that is the subject of a primary sales transaction is priced at $2,000,000, a second, different set of services can be suggested.

Additionally or alternatively, one or more services can be suggested based on time. Time includes time of day, day of the week, month of the year, and season of the year. Time also includes relative measures of time, such as the beginning, middle, closing, or post-closing points of a primary sales transaction. For example, at the beginning of a residential real estate sale, the service suggestion engine 210 can suggest a home inspection to a buyer. At the middle, the service suggestion engine 210 can suggest a mortgage loan. At closing, the service suggestion engine 210 can suggest a painting service. Post-closing, the service suggestion engine 210 can suggest a moving service. Other suggestions can be made to those in other roles as well.

The service suggestion engine 210 can take other factors, such as geographic location based on address or zip code, into account when determining what suggestions to make. For example, the service suggestion engine 210 can suggest one or more vendors within the same or within an adjacent zip code as a real estate parcel that is the subject of a primary sales transaction. Additionally or alternatively, the service suggestion engine 210 can suggest one or more vendors based on distance calculated between an address of a suggested vendor and an address of a real estate parcel that is the subject of a primary sales transaction.

The service suggestion engine 210 can analyze each system activity and patterns of system activity taken or engaged in by a user to determine a role for that user and to build a profile of preferences for that user that can be applied in other sessions involving that user. Specifically, these preferences can be applied when determining which services and vendors are to be suggested to the user. For example, if a user establishes a pattern of selecting vendors who can be characterized as small business enterprises, the service suggestion engine 210 can create a preference for that user. Based at least in part on that preference, the service suggestion engine 210 can reduce or eliminate suggestions for that user to obtain services from large chain stores. Other preferences can be established by analyzing user interactions with the system.

The service suggestion engine 210 can be implemented and used as part of a targeted advertising system. Advertising for proposed ancillary sales transactions can be or include suggestions of services and vendors from the service suggestion engine. This advertising can be targeted at users who occupy identified roles in a primary sales transaction. Those users can be included in targeted advertising campaigns through an opt-in system where a user must affirmatively grant consent, or though an opt-out system where consent of the user is presumed unless the user affirmatively revokes that consent.

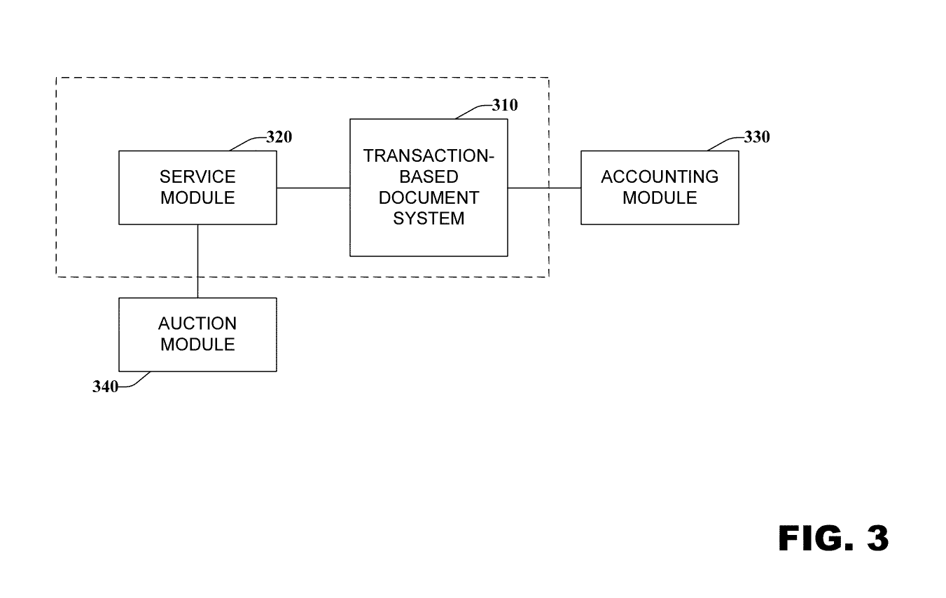

FIG. 3 is a system block diagram of a transaction-based document system 310 with associated business support modules. The transaction-based document system 310 can be implemented similarly to the transaction-based document creation and editing module 105 shown in FIG. 1 or can be implemented in another suitable manner. The transaction-based document system 310 can communicate with a services module 320. The services module 320 can be implemented to the services suggestion module 140 shown in FIG. 1, the service suggestion system 200 of FIG. 2, or in another suitable manner.

The transaction-based document system 310 can communicate with an accounting module 330. The accounting module 310 can track a variety of financial information related to suggestions made and information used by the services module 320. Specifically, the accounting module 330 can track and account for payments made by a vendor to be listed among vendors to be suggested to provide services to a user. The accounting module 330 can also track and account for fees from vendors paid when a suggested vendor is selected by a user to perform a service as part of an ancillary sales transaction. Other traditional accounting functions can be supported as well, including a variety of financial reporting functions.

The accounting module 310 can also support a revenue-sharing system. Specifically, revenue generated through use of the system from a variety of sources, which can include access fees for both users and service vendors, advertising fees, commissions from sales, and royalties from licensing, among others, can be shared with a variety of business affiliates. For example, a real estate broker who suggests to a vendor that the vendor use the system can be allocated a portion of any fees paid by that service vendor. In another example, a real estate broker can share in any revenue generated by user acceptance of ancillary transactions suggested by the system that are related to transactions in which the real estate broker is involved. Many other revenue sharing or affiliate programs can be established based at least in part upon the variety of cash flows that can be established among all the parties using the system.

An auction module 340 can be used to perform an auction or reverse auction among vendors to be suggested. In the case of an auction, the auction module 330 can manage a sale of a suggestion space of a vendor to the highest bidder. The winner of the suggestion space would be the vendor that is suggested to a user when that user receives a service suggestion. In the case of a reverse auction, the auction module 340 can manage the competition of vendors, including by limiting time available to compete, to perform a service that has been requested by a user. In one example, time can be used as a factor when determining how other auction activities are conducted. One instance of this feature can include a reduction in the number or type or both number and type of offers made depending on time that has elapsed since some specified point or a relative time to measure a point in a transaction. In an other instance, an offer can decrease in value to a recipient, such as when a price of an offered item or service increases over time or the amount of a discount decreases over time. Other forms of auctions and variations on auctions themes can be supported by the auction module 330 depending upon implementation.

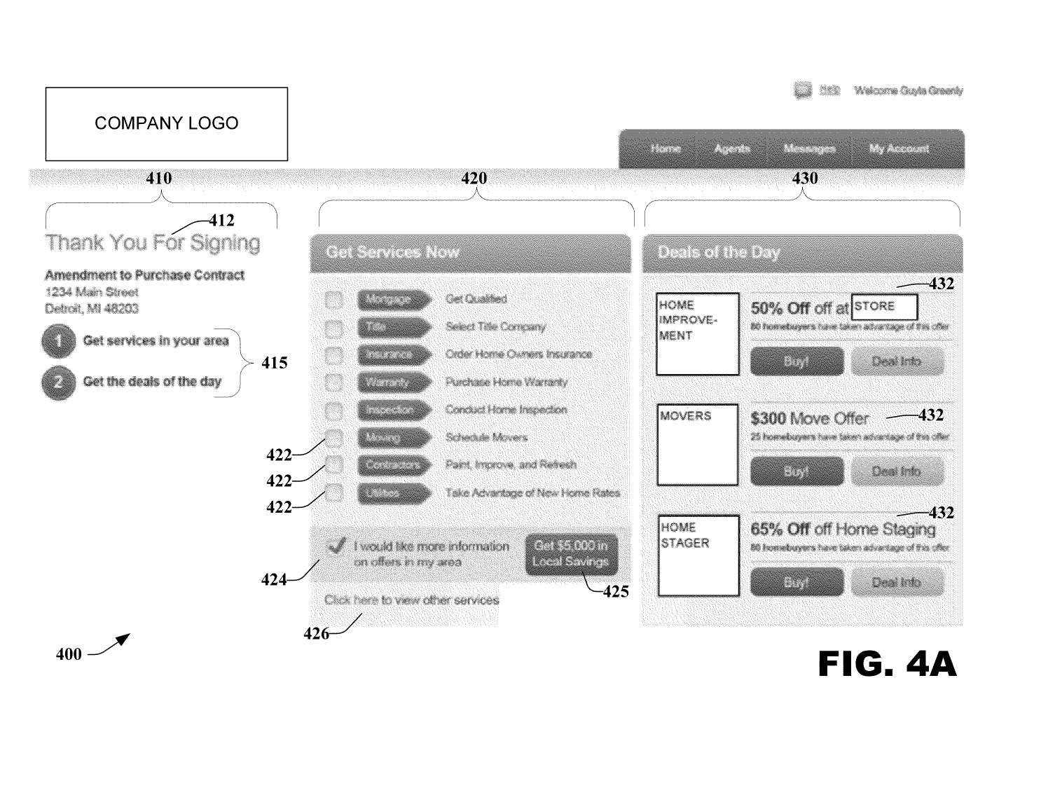

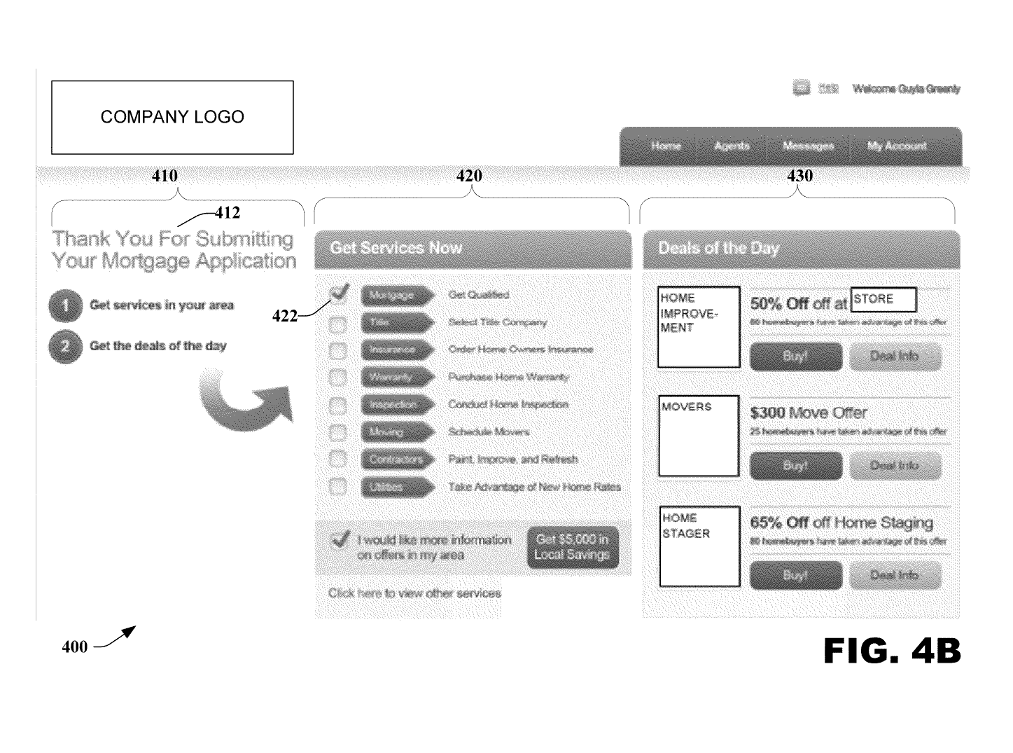

FIGS. 4A and 4B depict a user interface 400 that can be displayed to a user. The user interface 400 can be created as a web page or as a viewable portion of a client program running in a graphical user interface computing environment. Additionally or alternatively, the user interface 400 can be implemented as part of an HTML-formatted email message or in another suitable manner.

The user interface 400 can include a notification field 410. The notification field 410 can include a message field 412 that can be used to display a message to the user to inform the user that the system has taken some action. As shown in FIG. 4A, the message indicates that a user has electronically signed a purchase and sale contract for a residential real estate transaction. A user input field 415 is shown implemented as clickable web links that a user can activate to send requests to obtain information about services in the user's area or to receive targeted advertising that can include targeted offers, discounts, or other promotions.

A services field 420 can include a listing of user-selectable services 422. The listing is shown implemented as an HTML form with checkboxes next to each selectable item. By default, each item is shown as unselected in this example. Instead, each item, or some combination of items, could be selected by default. An information solicitation section 424 is shown at the bottom of the listing and is depicted as selected by default. In this example, clicking on a button 425 will submit the selection to permit a user to obtain more information on offers and can serve as an opt-in for solicitations and suggestions. A web link 426 can be clicked by a user to obtain further services-related information.

An offer field 430 can include advertised offers from selected merchants who can be charged for the ability to advertise and make offers to users. Each advertised offer 432 can be based at least in part upon a suggestion made by the service suggestion engine 145 shown in FIG. 1, or can simply be content for advertising space. As shown, at the point in time of the exemplary residential real estate transaction, suggested services can include sales of fixtures and building supplies, moving services, and home staging services.

The user interface 400 can be dynamically updated to reflect various actions taken by the user. For example, in FIG. 4B, the message shown in message field 412 has changed to indicate that a user has submitted a mortgage application. The checkbox for services listing 422 for mortgage services has been checked. The content of offer field 430 is shown unchanged.

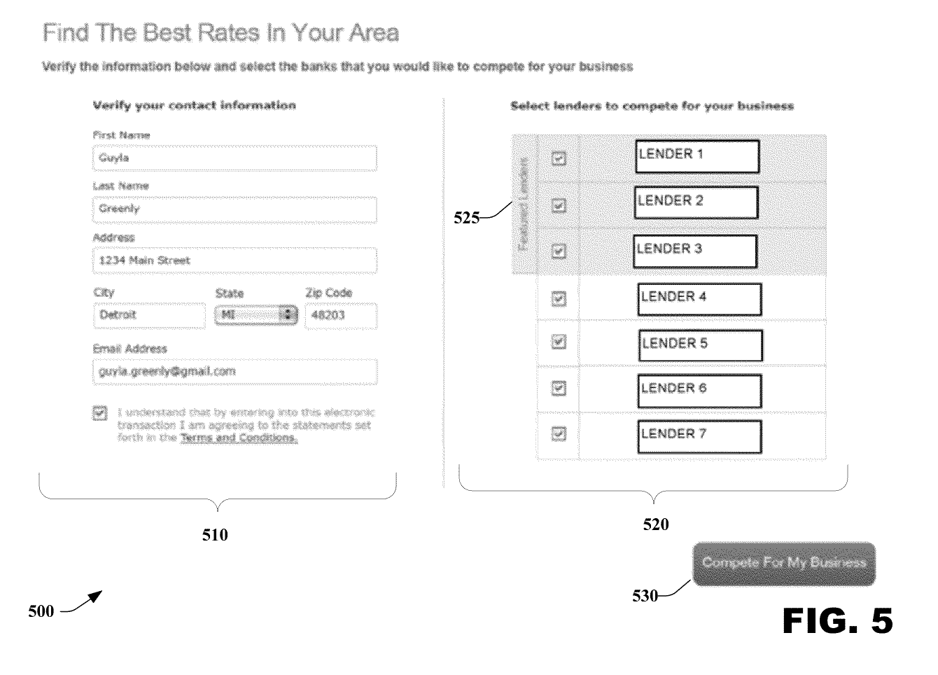

FIG. 5 depicts a user interface 500 for user initiation of a reverse auction implemented as an HTML form, although other interfaces can be used. This interface can be used by the user to supply to information into form section 510. In this example, the information is user identifying information to be used by one or more vendors. Vendors are listed in vendor selection section 520. Certain vendors are shown in a featured vendor section 525 and can be presented to a user in a manner that emphasizes their placement, such as by using a different background color or different typeface, among others.

The user interface 500 can be customized for each user and specifics can vary according to a role assigned to that user. For example, a range of activities permitted to a buyer can differ from a second range of activities permitted to a vendor, a broker, or a seller. The user interface 500 can display different options or commands as needed. For example, if the user interface 500 is being presented to a broker, the broker can select certain vendors to specifically recommend to a buyer or seller. In another example, if the user interface 500 is presented to a vendor, the vendor can begin or end advertising campaigns, submit new advertising materials, establish or terminate service offerings, participate in reverse auctions, or take other appropriate actions.

Vendors can be charged for listing as a featured vendor. Additionally, vendors can be rated and those ratings used to determine whether to suggest a specific vendor to a user. A user may have established a preference that the user only wishes to receive suggestions of vendors who have some specified minimum rating level. In that case, vendors whose ratings fall below the specified level will not be suggested to that user. Additionally or alternatively, a user with a seller or buyer role can optionally be told that a user occupying a broker role has specifically suggested a certain vendor.

A user can select one or more vendors to participate in the reverse auction. In this example, all vendors are shown selected by default. A user can exclude a vendor by deselecting a checkbox next to that vendor. Alternatively, all vendors could be unselected by default, or a subset of vendors, such as only featured vendors, could be selected by default. A user can submit the information and begin the reverse auction process by clicking on a submit button 530.

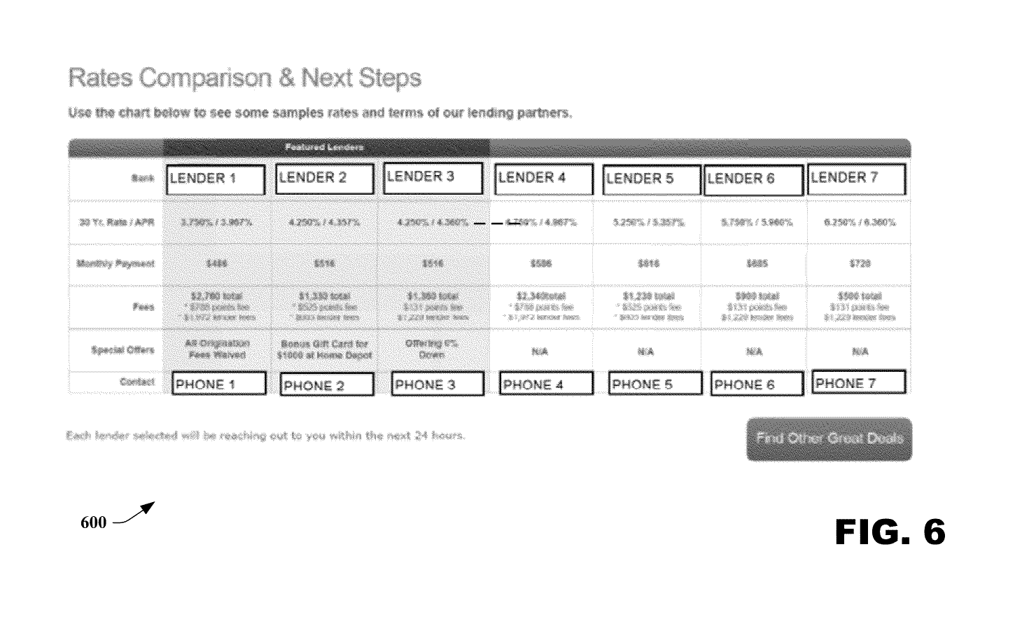

FIG. 6 depicts a comparison chart 600 that can be presented to a user through a user interface. In this specific example, the chart provides information related to vendors selected by a user to participate in a reverse auction and is formatted to allow direct comparisons of values of certain identified criteria such as monthly payments and interest rates for a residential home mortgage.

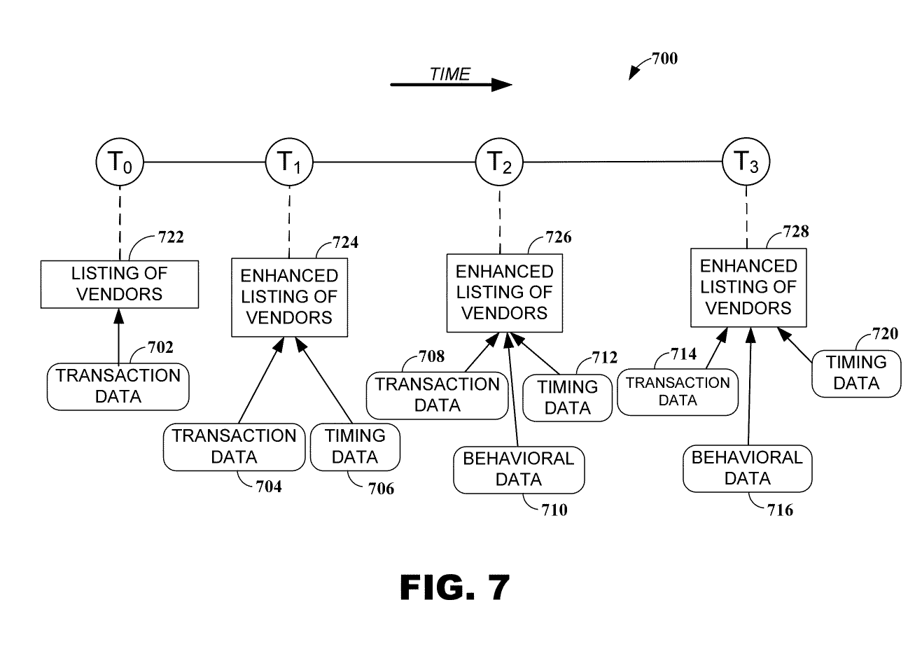

FIG. 7 shows an example progression 700 identifying suggested vendors over a period of time. The suggested vendor can vary over time as a transaction reaches different milestones, additional data becomes available, preferences are determined, and so forth. Merely for purposes of illustration, the progression 700 is described in the context of a real estate transaction. In one configuration, the listing of suggested vendors can be provided to a user of the transaction-based sales lead generation system 100 (FIG. 1), for example. The progression 700 may be applicable, however, to a wide variety of implementations.

At T₀, transaction data 702 can be used to determine an intitial listing of vendors 702. The transaction data 702 can include, for example, any of the following information: a property address, property characteristics (square footage, number of bedrooms, and so forth), type of property (residential/commercial), offer price, listing price, number of days on the market, lot size, neighborhood, school district, and so forth. The transaction data 702 may also be used to identify a party's role (buyer, seller, broker, and so forth). Other embodiments may utilize additional or alternative transaction data 702. In one example embodiment, the transaction-based document creation and editing module 105 (FIG. 1) gathers some or all of the transaction data 702. Some of the transaction data 702 can be provided by a real estate agent associated with the transaction and some of the transaction data 702 can be culled from documentation, user-provided information, and so forth.

The listing of vendors 722 can be listing of one or more vendors that are relevant to the transaction based on the transaction data 702. It is to be appreciated that the vendors included in the listing of vendors 722 can broadly include any relevant entity, including retailers, service providers, sole proprietorships, and so forth. The listing of vendors 722 can be provided to a user via a web page that is accessible through the web portal 250 (FIG. 2) or any other suitable communications technique. For example, the listing of vendors 722 can be provided in an email message, a text message, an instant message, or by direct mailing.

In the illustrated embodiment, the listing of vendors 722 provided at time T₀ includes vendors relevant to the early stages of a real estate transaction, such as mortgage brokers, furniture staging companies, contractors, and so forth. The particular lenders included in the listing of vendors 722 can be based on a geographic proximity to the property, the preferences of a real estate agent associated with the system, the size of the property, type of property, or any other suitable metric or parameter. Furthermore, the listing of vendors 722 can include, for example, offers, coupons, deals, or other advertisements associated with retailers, service providers, or other companies relevant to a user of the system.

The listing of vendors 722 can be displayed in any suitable format or groupings. In one embodiment, for example, the listing of vendors groups collections of vendors based on the services they provide (such as a group of home warranty vendors, a group of home inspection vendors, a group of pest inspection vendors and so forth). One or more suggested vendors can be identified in each group. The particular vendors that are identified within each group can be customized or refined in accordance with the system and methods described herein. In any event, in some configurations, the interaction by the user and the listing of vendors 722 can be monitored, stored, or otherwise tracked.

Moving now to T₁, an enhanced listing of vendors 724 is provided to a user. The enhanced listing of vendors 724 can be different from the listing of vendors 722. The enhanced listing of vendors 724 can be based on additional inputs or parameters. In the illustrated embodiment, transaction data 704 and timing data 706 are used to determine which vendors to identify in the enhanced listing of vendors 724. The transaction data 704 at T₁ may be different from the transaction data 702 at T₀ as more information is received about the transaction (such as the user's role, additional property information, and so forth), as the transaction progresses.

As the transaction meet different temporal milestones, different types of services can become more relevant to the party. For example, mortgage brokers may have been relevant at T₀, and now that the transaction is at T₁, moving companies may be considered relevant to the user. The timing data 706 can be used by the system to determine where temporally the parties are within the transaction. The timing data 706 can include, for example, the total number of days since the transaction commenced, an offer was accepted, or time from any other event of interest. The enhanced listing of vendors 724 can also include coupons, advertisements, deals, and so forth that are selected by the system based on the transaction data 704 and the timing data 706. Similar to the listing of vendors 722, the listing of vendors 724 can be provided to a user via any other suitable communications technique, such as via a web page through the web portal 250 (FIG. 2).

As a user interacts with the listing of vendors, coupons, deals, and so forth, a user's preferences may be determined, tracked or otherwise ascertained. In one configuration, the data collection tool 115 (FIG. 1), can be used to monitor a user's interaction with the system, such as which vendor the user selects. Other components or modules of the system may additionally or alternatively monitor the user's interactions and selections from the suggestions provided to them. The system can use these preferences, which can be stored by the system as behavioral data, to refine the listing of vendors subsequently presented to a user during the transaction or even a subsequent transaction. For example, the system may determine that a user prefers a particular type of retailer (national chain, locally owned, and so forth), service providors in particular geographic locations, or particular types of offers or promotions. These preferences can be used by the system to refine and customize the particular listing of vendors presented to the user.

Moving now to T₂, an enhanced listing of vendors 726 is identified. The enhanced listing of vendors 726 can be different from the listing of vendors 722 and the listing of vendors 726. While the enhanced listing of vendors 726 can be based on a variety of data, in the illustrated embodiment, the enhanced listing of vendors 716 is based on transaction data 708, behavioral data 710, and timing data 712. The transaction data 708 may or may not include additional data beyond the data included in transaction data 704. The behavioral data 710 may be information gleaned from the user's past interactions with the system. The behavioral data 710 can be used to determine tendencies or preferences of the user. By providing a listing of vendors that is tuned to the user's proclivities, the likelihood that the user will select a service from one of the vendors may potentially be increased. The behavioral data 710 can be used to determine which vendors to include in the list based on, for example, vendor characteristics, vendor location, and promotion type. As is to be appreciated, a wide variety of vendor characteristics could be used in varying implementations. In any event, vendor characteristics could include type of store (national retailer vs. locally owned), number of employees, customer feedback ranking, average pricing, and so forth. The behavioral data 710 can also be used to determine that a user is more likely to select a vendor offering a promotion of a particular value (such as exceeding 20% off a purchase price). By way of example, if a user tends to select vendors that are national retailers, the vendors included in the listing of vendors 726 can be predominantly national retailers. Alternatively or additionally, coupons or deals from national retailers may be presented to the user. The coupon or deals may be presented at a pop-up window, for example, on a user interface.

Still referring to T₂, the timing data 712 can be used by the system to determine the particular stage of the transaction. At different stages of the transaction, certain services can be of increased importance or relevance and can be presented to the user at the proper time. By sequencing the listing of vendors provided to the user over time, the user is provided with a listing of vendors that is particularly relevant to the needs of that user at a given point in time.

Referring now to T₃ of FIG. 7, an enhanced listing of vendors 728 is provided to a user. While the enhanced listing of vendors 728 can be based on a wide variety available data, in the illustrated embodiment the enhanced listing of vendors 728 is based on transaction data 714, behavioral data 716 and timing data 720. The transaction data 714 may or may not be the same as the previous transaction data available to the system The behavioral data 716 can take into account, for example, the user's interactions with the enhanced listing of vendors 726 presented at T₂. Based on these interactions, the user's tendencies or preferences can be monitored such that the vendors included in the enhanced listing of vendors 728 are selected to potentially match the user's preferences.

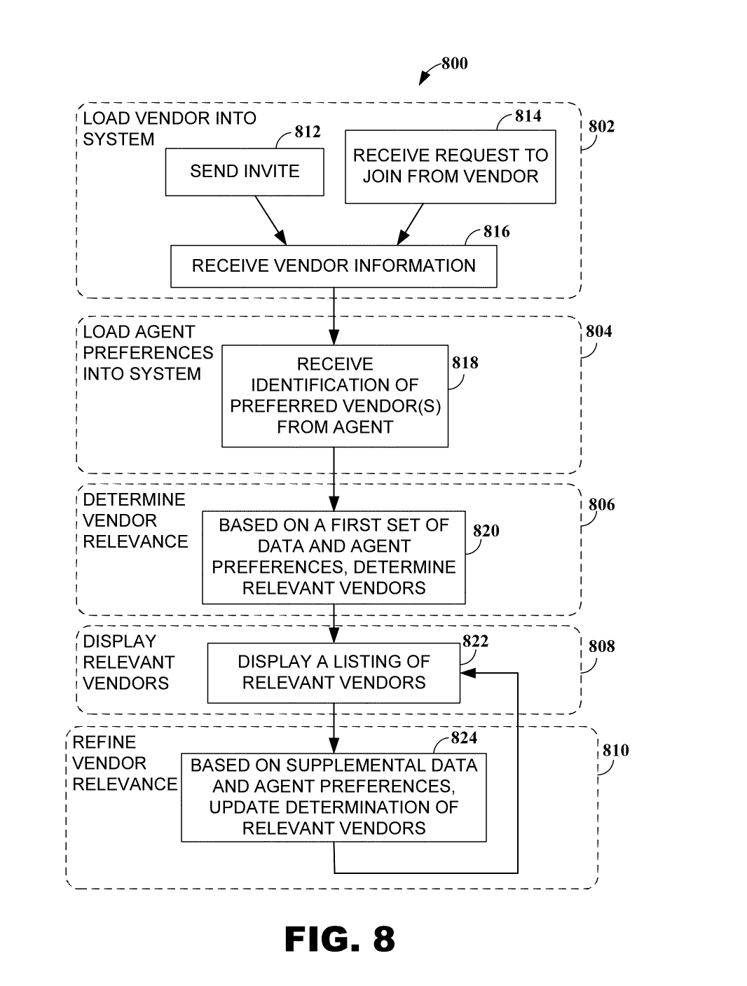

FIG. 8 is a flow diagram 800 of an example operation of the generation of relevant vendor listings. As described in more detail below, the relevant vendor listings can be at least partially based on real estate agent preferences. The flow diagram 800 generally includes loading vendors into the system at 802, loading agent preferences into the system and 804, determining vendor relevance at 806, displaying relevant vendors at 808, and refining vendor relevance at 810. It is to be readily appreciated, however, that the flow diagram 800 merely shows own example configuration and that the flow diagram 800 may vary in other configurations. To those ends, the flow diagram for other configuration may include more or less elements and the particular order of the various elements shown in the flow diagram 800 may differ.

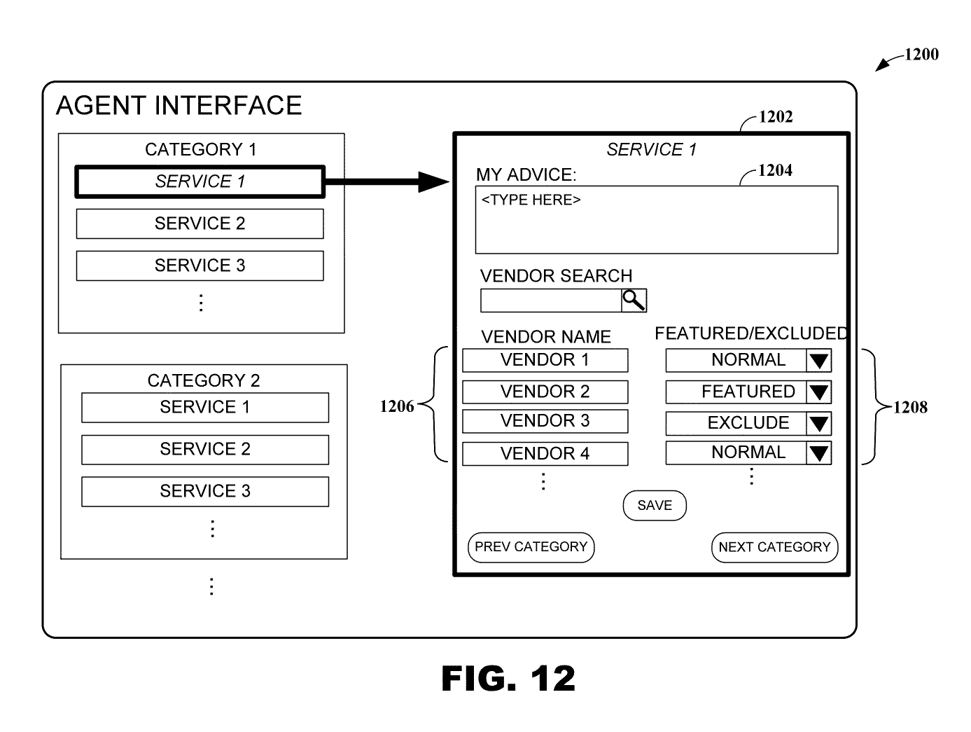

Vendor information can be loaded into the system using any suitable technique. For example, a real estate agent may, through an agent interface, initiate the sending of an electronic invitation to a vendor at 812. An example interface is described in more detail below with regard to FIG. 12. The invitation can be in the form of an email message, instant message, text message, or any other suitable message format. The invitation can request the service provider to register with the system. The registration process can provide vendor information to the system that can later be used by the system to determine the relevance of that particular vendor to a particular transaction.

Instead of receiving an invitation, a vendor can initiate the process by submitting a request to join the system at 814. Upon receiving the vendor request, the system can require the vendor to register with the system via a registration process. In any event, the system receives vendor information at 816. The vendor information can include, for example, the vendor's addresses, geographical areas serviced, number of employees, annual revenue, types of customers served, services provided, website address, contact information, and so forth. The vendor can also supply information regarding when their services are typically purchased. The vendor information can be stored in a vendor profile. In some embodiments, an approval or verification process can be performed subsequent to receiving the vendor information.

In some configurations, preferences of a real estate agent can be used by the system to aid in determining which vendors to recommend to a user. At 818, an identification of one or more preferred vendors is received from an agent. While the illustrated embodiment shows the agent providing an indication of preferred vendors, other embodiments may utilize a ranking system or other technique to demarcate vendors based on real estate agent preferences. For example, a real estate agent can assign various vendors with a score which is used by the system to determine which vendors are relevant to a particular user. In that way, if a real estate agent has received verbal feedback about various service providers, the real estate agent can quantify that feedback in the form of a score and input the score into the system. Once a transaction has commenced, and the system has at least some data regarding the transaction, the system can determine relevant vendors for the particular transaction at 820. This determination can be based on, for example, a first set of data and the agent preferences. The first set of data can include transaction data, timing data, and behavioral data, as described above with regard to FIG. 7. Depending upon the stage of the transaction, the data available may be limited to the property address, for example. The agent preferences, as received at 818, can also be used as a factor in making the determination. A wide variety of other variables may be used in making the determination, such as the services offered by the vendor, the location of the vendor, user feedback scores of the vendor, price points, and so forth.

At 822, the listing of relevant vendors is displayed to a user of the system, with the user being a party to the transaction. While the particular format for displaying the relevant vendors may vary, in some configurations, various vendors in the list can be highlighted as a “preferred vendor” or “exclusive vendor” of an associated real estate agent.

At 824, the determination of relevant vendors can be updated, refined or otherwise customized. The vendor list can be updated based on the stage of the transaction, a change to the real estate agent preferences, past interactions with the system by the user, or other data or feedback. Once the relevant vendors has been updated, the listing of the relevant vendors can again be presented to the user at 822. The general process of presenting a list of vendors and then refining the list of vendors as more information becomes available can repeat until the transaction completes. It is noted that while the flow diagram 800 is described in terms of vendors, this disclosure is not so limited. Additionally or alternatively, any coupons, deals, or promotions presented to the user through the system can be based on the methodology shown in flow diagram 800.

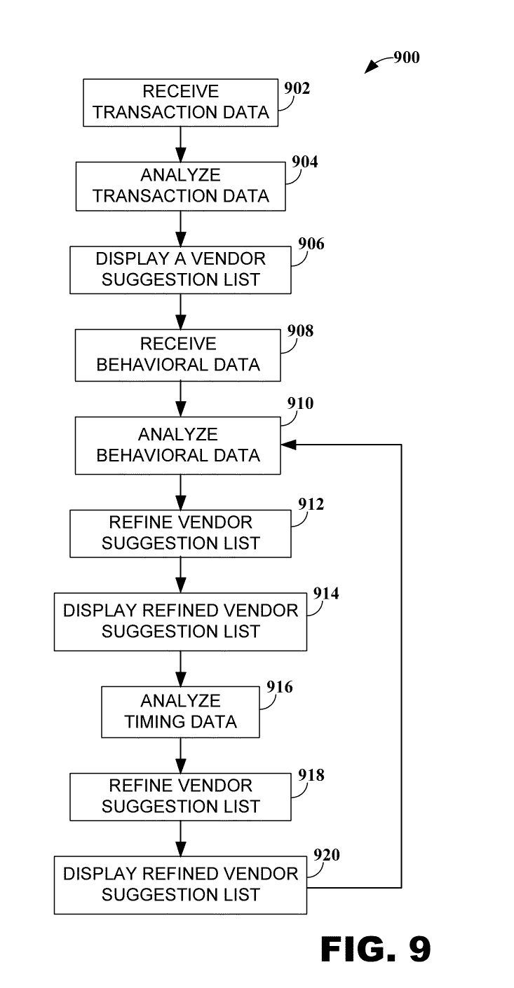

FIG. 9 is a flow diagram 900 of an example operation of generating a vendor suggestion list based on a variety of available data. At 902, transaction data is received. The transaction data can be, for example, information gleaned from a real estate offer, information inputted by a real estate agent, information gleaned from a property listing, or any other information source. At 904, the transaction data is analyzed to determine, for example, the roles are various participants in the transaction and real estate property characteristics. Based on the transaction data, at 906, a vendor suggestion list is displayed. The particular vendors included on the vendor suggestion list can be based on the transaction data. By way of example, only vendors without a certain geographic radius of the property address can be included in the vendor suggestion list. As another example, only vendors relevant to the particular stage of the transaction can be displayed. The particular stage of the transaction can be determined through a variety of techniques, such as determining which type of documents are being exchanged between parties or how long the transaction has been transpiring, for example. If an offer to purchase real estate is being provided to a seller by a buyer, the buyer would likely be interested in mortgage lending services. Whereas, if closing documents are being exchanged between parties, a different set of vendors relevant to the final stages of a real estate transaction can be displayed to the user.

At 908, behavioral data is received by the system. Behavioral data can include a wide variety of input, such as a log of the user's selections and the amount of time a user spends navigating the system, for example. At 910, the behavioral data is analyzed to determine user preferences or inclinations. For example, through analysis of the behavioral data, the system may determine a particular user is more likely to purchase services from a vendor having one or more particular characteristics. The system can then refine the vendor suggestion list to include more vendors having those particular characteristics. In another implementation, through analysis of the behavioral data, the system may determine that a particular user is more likely to redeem a coupon or promotion having a particular structure (such as buy one get one free). The system can then refine the vendor suggestion list to include more vendors offering coupons or promotions having that particular structure. In any event, at 912, the vendor suggestion list can be refined based on the user's interaction with the system. At 914, the refined vendor suggestion list is displayed.

In addition to transaction data and behavioral data, other data may be used to refine the vendor suggestion list. At 916, for example, timing data is analyzed. Through analysis of timing data the system can infer at which stage a transaction is in, and in turn, determine which types of services a party to the transaction likely needs. At 918, the vendor suggestion list can be refined based on the time data. At 920, the refined vendor suggestion list is displayed. As shown in FIG. 9, the process flow can return to analyze behavioral data at 910 to further refine the vendor suggestion list.

A particular vendor or service provider may not be considered relevant over the entire course of the transaction. At different stages of the transaction, the relevance of various vendors can increase or decrease. From the user's perspective, the vendor suggestion list is in tune with the decisions they are making and services they need throughout the course of the transaction. The vendor suggestion list can also be refined or tuned so that as additional information regarding the user or the transaction is available; the vendor suggestion list becomes increasing relevant or useful to the user.

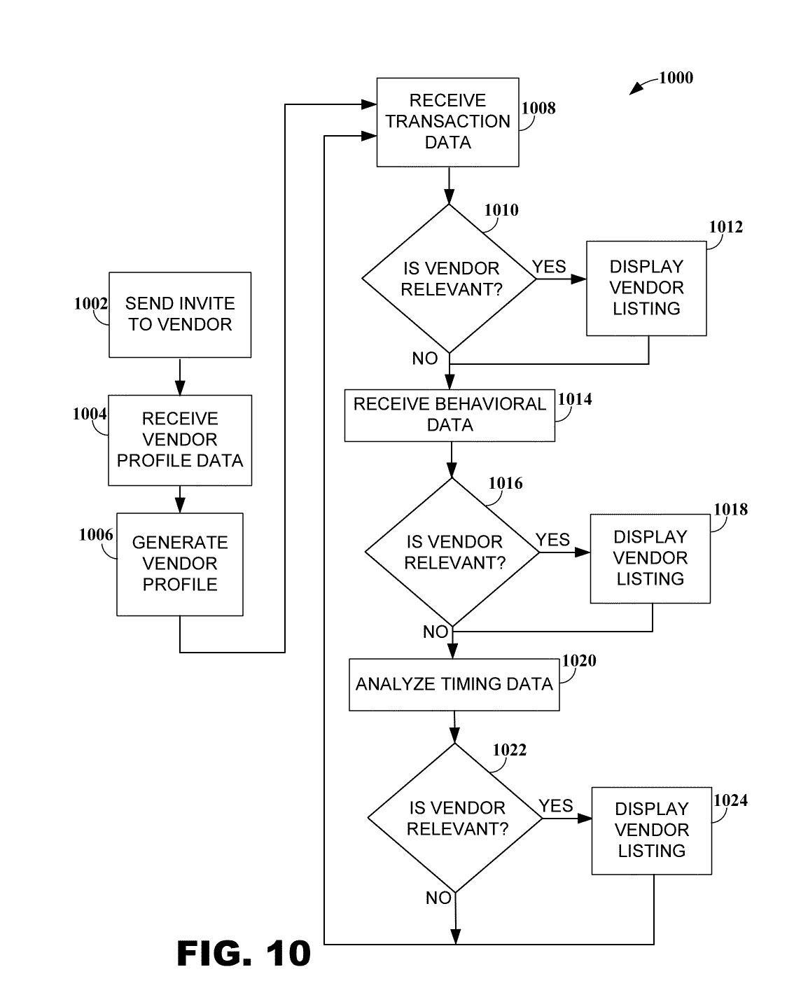

FIG. 10 is a flow diagram 1000 of an example operation to determine the relevance of an example vendor. At 1002, an invite is sent to a vendor. The invite can be in the form of an electronic message or other suitable form of communication. The sending of the invite can be initiated by a real estate agent, broker, or any other user of the system. At 1004, vendor profile data is received. The vendor profile data can be received via an online registration process, for example. In one embodiment, the invite includes a web link that once accessed by the vendor, directs the vendor to an online portal for supplying information. Vendor profile data can include any relevant data, such as address, services provided, promotions, discounts, number of years in business, ownership data, website address, and so forth. At 1006, a vendor profile is generated. As is to be readily appreciated, the profile can be stored in an associated memory store using any suitable storage technique. While not shown in FIG. 10, the process can also include a vendor approval or verification process.

At 1008, transaction data is received. Transaction data can be any information related to an underlying transaction. In the case of a real estate transaction, transaction data can include, for example, a property's address, square footage, lot size, and so forth. At 1010, it is determined if the vendor is relevant to the transaction. If the vendor is relevant, the vendor listing is displayed at 1012. Again, in the context of a real estate transaction, a mortgage lender may be considered a relevant vendor at this stage, while a moving company would not be considered a relevant service provider. If the vendor is not relevant, behavioral data is received by the system at 1014. Behavioral data can be used to identify, for example, the common characteristics of the vendors that are selected by the user. Through the received behavioral data it may be determined, for example that the user is more likely to select vendors from a certain geographic area or vendors offering a particular type of promotion or coupon. Based on the behavioral data, at 1016 it is determined if the vendor is relevant. By way of example, the behavioral data may indicate that the user prefers large national retailers, if the vendor is a large national retailer, the vendor listing is displayed at 1018.

At 1020, timing data can be analyzed. The timing data can be used to ascertain, or otherwise approximate, in which transaction stage the user is experiencing. For example, in a real estate transaction, certain milestones may typically happen around certain times. A company offering cable/internet to new homeowners is likely to be more relevant once the real estate transaction is nearing closing. If the timing data indicates that closing is soon, the service provider offering the cable/internet deal can be displayed to the user. After an offer is accepted, home inspections usually occur within a certain time window and lending is typically secured within a certain time window. Other services may be secured within typical time windows as well, such as moving services, cable/internet services, and so forth. Some services may be tied to other services. For example, home repair services may typically be needed about one week after a home inspection has been performed. Based on the timing data analyzed at 1020, the system can determine which types of services are likely relevant to the user. At 1022, it is determined if the vendor is relevant 1022. If the vendor is relevant, at 1024 the vendor listing is displayed.

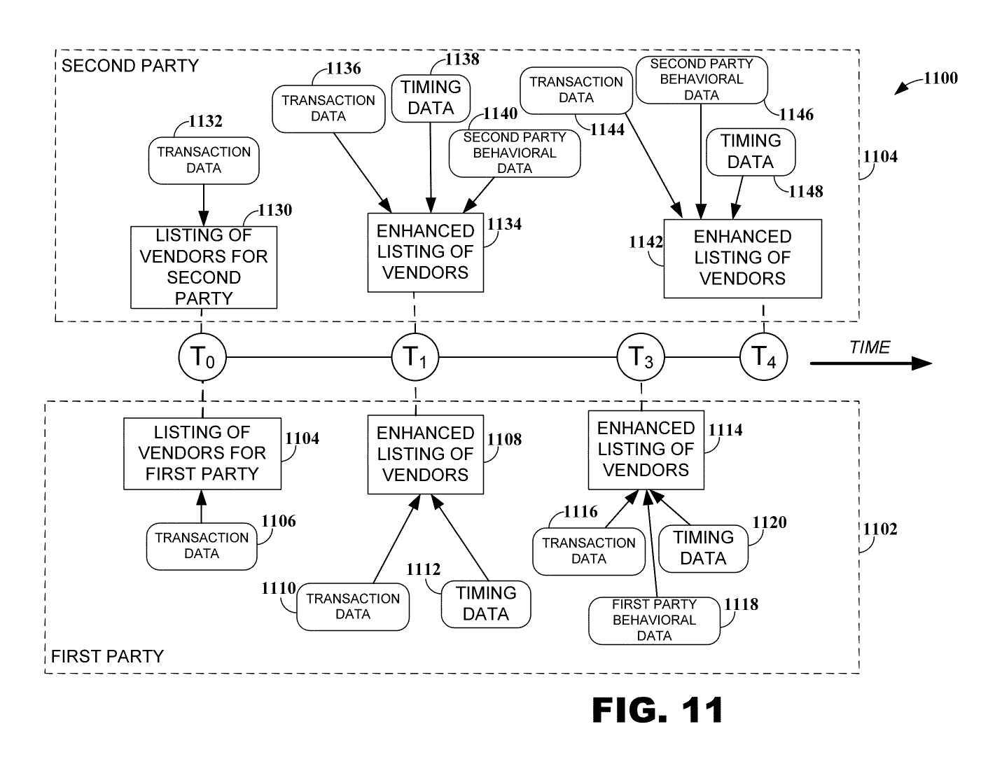

In the context of real estate transaction, there are typically at least two parties involved in the transaction (buyer and seller). The systems and methods described herein can be used to provide relevant vendor listings to each of a plurality of parties that are associated with a transaction. Due to the differing roles, the particular vendors suggested for the various parties can differ. A buyer may be interested in mortgage broker services, while a seller may be interested in moving company services. FIG. 11 shows an example progression 1100 of suggested vendors over time for a first party 1102 and second party 1104. Referring first to the first party 1102, a listing of vendors for the first party 1104 is determined at T₀. In the illustrated embodiment, the listing of vendors for the first party 1104 is based on transaction data 1106. Similar to previously described embodiments, the transaction data 1106 can include information regarding the underlying transaction, such as a property address, offer price, closing date, and so forth. As shown in FIG. 11, at T₀, a listing of vendors for the second party 1130 can also be determined.

While FIG. 11 shows the listing of vendors for the first party 1104 and the listing of vendors for the second party 1130 being determined or provide at the same time (T₀), this disclosure is not so limited. In some configurations, the listing of vendors for the first party 1104 may be provided to the first party 1102 at a different point in time from when the listing of vendors for the second party 1130 is provided to the second party 1104. The actual point in time that the listing is provided may correspond, for example, with when the particular user logs in, or otherwise accesses, the system. In some embodiments, the listing of vendors can be delivered to various parties via an electronic communication, such as an email message, text message, or an instant messaging protocol, for example. As illustrated, the listing of vendors for the second party 1130 can be based on transaction data 1132. Transaction data 1132 can be the same or different from the transaction data 1106. The transaction data 1106, 1132 may identify roles of the first party and the second party which allows the lists of vendors provided to each party to be relevant to their role.

At a subsequent point in time, shown as T₁, an enhanced listing of vendors 1108 is provided to the first party 1102 and an enhanced listing of vendors 1134 is provided to the second party 1104. As discussed above, the role of the party can be used as a factor in determining which vendors to include on the list. The enhanced listing of vendors 1108 is also based on the transaction data 1110 and timing data 1112, both of which are described above. The enhanced listing of vendors 1134 is based on transaction data 1136, timing data 1138, and second party behavioral data 1140. The second party behavioral data 1140 can be based on, for example, the second party's interactions with the listing of vendors 1130 provided at T₀. Based on that interaction, the system can profile that user's preferences or tendencies to refine the vendors that are suggested.

Depending on the type of transaction and the roles of the parties, the points in time which various vendors are recommended to the various parties may not necessarily be concurrent. For example, in the real estate sales context, the buyer may be sequentially presented with a series of vendors at the beginning of the transaction while the suggested vendors presented to the seller may remain relatively stagnant. Towards the end of the transaction, the trend may reverse, with the seller being presented with a series of vendor lists as the seller reaches different milestones. At T₃ of FIG. 11, for example, an enhanced listing of vendors 1114 is presented to the first party 1102 even though the listing of vendors for the second party 1104 is not updated. As shown, the enhanced listing of vendors 1114 can be based on a wide variety of data or inputs, such as transaction data 1116, first party behavioral data 1120, and timing data 1120. Looking now at T₄, an enhanced listing of vendors 1142 is presented to the second party 1104 even though the listing of vendors for the first party 1102 is not updated. As shown, the enhanced listing of vendors 1142 can be based on a wide variety of data or inputs, such as transaction data 1144, second party behavioral data 1146, and timing data 1148.

In some configurations, a real estate agent's preferences can be taken into account when determining which vendors to include in the various listing of vendors supplied to the user. A first real estate agent can be affiliated with the first user 1102 and a second real estate agent can be affiliated with the second user 1104. As such, preferences of the first real estate agent can affect the listing of vendors shown to the first user 1102 and the preferences of the second real estate agent can affect the listing of vendors shown to the first user 1104.

FIG. 12 is a diagram of an example real estate agent user interface 1200. As is to be appreciated, the user interface 1200 is merely an example implementation and a wide variety of other user interfaces can be used. For example, some interface can be configured for smart phones, tablet computers, and the like. The user interface 1200 can be used by a real estate agent to customize or otherwise influence the particular service providers, vendors, and retailers that are presented to their client's during a transaction. In the illustrated embodiment, various services are divided into categories, such as category 1 and category 2. By way of example, the services in category 1 can relate to buying a home and the services in category 2 can relate to selling a home. As is to be appreciated, other categories can be used, such as home improvement, relocation services, and so forth. Within each category can be a list of related services. In the illustrated example, service 1 could be home staging services, service 2 could be home inspection services, and service 3 could be home appraisal services. Through interactions with the system, the real estate agent can customize the vendors associated with each service. As shown in field 1202, the real estate agent can enter advice which can be conveyed to their client during the transaction in field 1204. Field 1202 also includes a listing of vendors 1206 that provide service 1. In the illustrated embodiment, vendor 1, vendor 2, vendor 3, and vendor 4 are shown to provide service 1. As provided above, information regarding these vendors may have previously been obtained and verified through a vendor registration process. The agent can then assign a status to one or more vendors. Through drop-down menus 1208 the real estate agent can dynamically adjust vendor status. In the illustrated embodiment, for each vender, the real estate agent can select “normal,” “featured,” and “excluded.” As it to be readily appreciated, other preferences or status identifiers can be used in other embodiments. These preferences can be taken into the account when the system displays a list of relevant venders to a user.

It should be noted that one or more examples of one or more specific implementations may contain language that indicates that a component or feature is mandatory, and it should be understood that such mandatory language indicates at most that component or feature may be mandatory for that specific implementation only.

What has been described above includes examples. It is, of course, not possible to describe every conceivable combination of components or methodologies for purposes of describing the disclosed systems and methods, but one of ordinary skill in the art may recognize that many further combinations and permutations of the subject invention are possible. Accordingly, the disclosed systems and methods are intended to embrace all such appropriate alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the disclosed systems and methods include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A non-transitory computer readable medium having instructions stored thereon, which when executed by a processor cause the processor to:
receive vendor data for each of a plurality of vendors;
receive first data associated with a transaction;
based on the first data and the vendor data for each of a plurality of vendors, determine a first plurality of suggested vendors, wherein the first plurality of suggested vendors is a subset of the plurality of vendors;
subsequent to receiving the first data, receive second data associated with the transaction; and
based at least on the second data and the vendor data for each of a plurality of vendors, determine a second plurality of suggested vendors, wherein the second plurality of suggested vendors is a subset of the plurality of vendors and the second plurality of suggested vendors is different than the first plurality of suggested vendors.

2. The non-transitory computer readable medium of claim 1, wherein the first data is transaction data associated with the transaction, and the second data is timing data associated with a progression of the transaction.

3. The non-transitory computer readable medium of claim 1, wherein the transaction is a sales-based transaction.

4. The non-transitory computer readable medium of claim 3, wherein the sales-based transaction is a real estate sales transaction.

5. The non-transitory computer readable medium of claim 4, wherein the transaction data comprises data real estate location data, square footage data, and sales price data.

6. The non-transitory computer readable medium of claim 4, having instructions stored thereon, which when executed by a processor cause the processor to:
receive real estate agent vendor preference data, wherein the determination of at least one of the first plurality of suggested vendors and the second plurality of suggested vendors is at least partially based on the real estate agent vendor preference data.

7. The non-transitory computer readable medium of claim 23, having instructions stored thereon, which when executed by a processor cause the processor to:
receive, from the party to the transaction, a selection of a vendor from the second plurality of suggested vendors;
determine at least one vendor characteristic of the selected vendor, and wherein the third plurality of suggested vendors comprises at least one vendor from the plurality of vendors having the least one vendor characteristic.

8. The non-transitory computer readable medium of claim 7, wherein the at least one vendor characteristic comprises any of geographic data and pricing data.

9. The non-transitory computer readable medium of claim 1, having instructions stored thereon, which when executed by a processor cause the processor to:
cause the display of an indication of each of the first plurality of suggested vendors on a user interface associated with the party; and
subsequent to causing the display of the indication of each of the first plurality of suggested vendors, cause the display of an indication of each of the second plurality of suggested vendors on the graphical user interface associated with the party.

10. A computer-implemented method, comprising:
storing, in a vendor data store, vendor data for each of plurality of vendors;
during a transaction between a first party and a second party facilitated through a web-based interface:
determine by a processor, based on characteristics of the transaction and the vendor data, a set of suggested vendors from the plurality of vendors;
cause a display on the web-based interface of the name of each suggested vendor in the set of suggested vendors;
subsequent to causing the display of the name of each suggested vendor in the set of suggested vendors, refine the set of suggested vendors based at least partially on at least one of timing data and behavioral data;
cause the display on the web-based interface of the name of each suggested vendor in the refined set of suggested vendors.

11. A computer-implemented method of claim 10, comprising:
determining by a user role module a role of the first party and a role of the second party.

12. A computer-implemented method of claim 11, wherein the set of suggested vendors is further based on the role determined by the user role module.

13. A computer-implemented method of claim 12, comprising:
causing the display of the name of each suggested vendor in a first set of suggested vendors to the first party based at least in part on the role of the first party; and
causing the display of the name of each suggested vendor in a second set of suggested vendors to the second party based at least in part on the role of the second party, wherein the first set of suggested vendors is different than the second set of suggested vendors.

14. A computer-implemented method of claim 13, comprising:
refining the first set of suggested vendors based on behavioral data of the first party; and
refining the second set of suggested vendors based on behavioral data of the second party.

15. A computer-implemented method of claim 14, wherein the transaction is a real estate sales transaction.

16. A computer-implemented method of claim 15, wherein each of the set of suggested vendors and the refined set of suggested vendors is further based on at least one vendor preference of a real estate agent associated with the real estate sales transaction.

17. An system, comprising:
a user role module configured to identify a role of a party to a transaction facilitated through a graphical user interface;
a vendor data store configured to store at a vendor profile for each of a plurality of vendors;
a rules data store configured to store rules to determine suggested vendors; and
a vendor suggestion module configured to:
receive transaction data; and
based on an identified role of the party, the rules stored in the rules data store, the transaction data, and the at least one vendor profile, determine a first suggested vendor from the plurality of vendors.

18. The system of claim 17, wherein the transaction is a real estate transaction and the user role module is further configured to determine the role of the party as one of a purchaser of real estate and a seller of real estate.

19. The system of claim 17, wherein the vendor suggestion module is further configured to receive vendor preference data from a real estate agent associated with the transaction and determine the first suggested vendor based at least in part upon the vendor preference data.

20. The system of claim 17, wherein when a first party and a second party are each associated with the transaction, the vendor suggestion module is further configured to:
based on an identified role of the first party, the rules stored in the rules data store, the transaction data, and the at least one vendor profile, determine a first party suggested vendor; and
based on an identified role of the second party, the rules stored in the rules data store, the transaction data, and the at least one vendor profile, determine a second party suggested vendor, wherein the first party suggested vendor and the second party suggested vendor are different.

21. The system of claim 17, the vendor suggestion module is further configured to monitor vendor selections by each of the first party and the second party to determine first party behavioral data and second party behavioral data.

22. The system of claim 17, wherein each of a plurality of vendors is any of a retailer and a service provider.

23. The non-transitory computer readable medium of claim 4, having instructions stored thereon, which when executed by a processor cause the processor to:
subsequent to receiving the second data, receive third data associated with a party to the transaction; and
based at least on the third data and the vendor data for each of a plurality of vendors, determine a third plurality of suggested vendors, wherein the third plurality of suggested vendors is a subset of the plurality of vendors and the third plurality of suggested vendors is different than both the first and second pluralities of suggested vendors.

24. The non-transitory computer readable medium of claim 23, wherein the third data is behavioral data associated with the party to the transaction.

25. The system of claim 17, wherein the vendor suggestion module is configured to:
based on the identified role of the party, timing data, the rules stored in the rules data store, and the at least one vendor profile, determine a second suggested vendor from the plurality of vendors.

26. The system of claim 25, wherein the vendor suggestion module is configured to:
based on the identified role of the party, behavioral data of the party, the rules stored in the rules data store, and the at least one vendor profile, determine a third suggested vendor from the plurality of vendors.
